(19) United States
(12) Patent Application Publication
(10) Pub. No.: US 2025/0141344 A1
(43) Pub. Date: May 1, 2025

(54) SWITCHING POWER SUPPLY AND CONTROL METHOD FOR SWITCHING POWER SUPPLY

(71) Applicant: Delta Electronics (Shanghai) CO., LTD., Shanghai (CN)

(72) Inventors: Yong HU, Shanghai (CN); Xinghua ZHANG, Shanghai (CN)

(73) Assignee: Delta Electronics (Shanghai) CO., LTD., Shanghai (CN)

(21) Appl. No.: 18/915,416

(22) Filed: Oct. 15, 2024

(30) Foreign Application Priority Data
Oct. 30, 2023 (CN) 2023114243737

(51) Int. Cl. H02M 1/32; H02M 1/00; H02M 1/42; H02M 7/219

(52) U.S. Cl. CPC H02M 1/327; H02M 1/0003; H02M 1/4233; H02M 1/4291; H02M 7/219

(57) ABSTRACT

The present disclosure provides a switching power supply and a control method for a switching power supply, and relates to the technical field of power supply. The method includes: detecting a temperature of a bus capacitor and determining temperature information of the bus capacitor, where an input terminal of a PFC boost circuit is connected to a power source, and the bus capacitor is located at an output terminal of the PFC boost circuit; and adjusting a voltage across the bus capacitor in a preset manner according to the temperature information of the bus capacitor.

### CROSS REFERENCE

This application is based upon and claims priority to Chinese Patent Application No. 2023114243737, filed on Oct. 30, 2023, the entire contents thereof are incorporated herein by reference.

### TECHNICAL FIELD

The present disclosure relates to the technical field of power supply, and particularly, to a switching power supply and a control method for a switching power supply.

### BACKGROUND

Under the premise of using a natural cooling manner to dissipate heat, a power supply of a high-power light-emitting diode (LED) not only needs to work in outdoor high-temperature conditions, but also requires long product life. Therefore, the power supply of LED must be characterized by high efficiency. Since the output voltage of a high-power LED driver is up to 300V˜600V, and the LED lamp itself needs to have enough insulation strength, an isolation and a non-isolation between the input and the output are both acceptable for the LED driver. The non-isolated topology has the advantages of having the fewest components and the highest efficiency, and can effectively improve the heat dissipation performance compared with the isolated topology. A typical high-power non-isolated two-stage topology is a boost power factor correction (Boost PFC) combined with a Buck. From the point of view of improving efficiency, the lower the voltage difference between the input and output of the power factor correction stage (PFC stage) and the Buck stage, the higher the efficiency.

Due to the characteristics of the occasion where the products are used, products with designs of high-power LED power supply must be required to be applicable to the ambient temperature of −40˜70° C., and to ensure the quality of lighting, and must not allow lights flickering. However, the performance of electrolytic capacitors will decline significantly at low temperatures. For the output bus of power factor correction (PFC), the reduction in capacitance value will cause the bus voltage ripple to become larger, which will affect the operation of the second stage circuit. When the second stage Buck circuit cannot adjust, the ripple voltage of the bus is directly output to the load side; in particular, for lighting loads such as LEDs, it will often be manifested as flickering or triggering a protection leading to a failure to start, which are unacceptable for lighting products.

It can be seen that existing high-power power supplies are unable to meet both high efficiency and long life time, and there is a problem of poor start-up due to the low-temperature characteristics of the electrolytic capacitor.

It should be noted that the information disclosed in the above background is only used to enhance an understanding of the background of the present disclosure, therefore it may include information that does not constitute the prior art known to those skilled in the art.

### SUMMARY

The present disclosure provides a switching power supply and a control method for a switching power supply, which at least to a certain extent overcome the problems of the high-power power supplies in the related art not being able to achieve both high efficiency/long life time, and good start-up at low temperature due to the low temperature characteristics of the electrolytic capacitor.

Other features and advantages of the present disclosure will become apparent through the following detailed description, or, may be learned partially by practice of the present disclosure.

According to a first aspect of the present disclosure, a switching power supply is provided, including: a PFC boost circuit, a bus capacitor, a detection unit and a control unit; where an input terminal of the PFC boost circuit is connected to a power source; the bus capacitor is located at an output terminal of the PFC boost circuit; the detection unit is configured to detect a temperature of an internal component of the switching power supply and output temperature information; and the control unit is coupled to the detection unit and configured to adjust a voltage across the bus capacitor in a preset manner according to the temperature information output by the detection unit.

In some embodiments of the present disclosure, the internal component of the switching power supply is the bus capacitor.

In some embodiments of the present disclosure, the control unit inversely adjusts the voltage across the bus capacitor according to the temperature information.

In some embodiments of the present disclosure, a temperature signal processing unit is configured to adjust the voltage across the bus capacitor in a following manner: in response to that the received temperature information is lower than a preset threshold, adjusting the voltage across the bus capacitor to a first voltage according to a first preset value, and in response to that the received temperature information is greater than a preset threshold, adjusting the voltage across the bus capacitor to a second voltage according to a second preset value, where the first voltage is greater than the second voltage.

In some embodiments of the present disclosure, a temperature signal processing unit is configured to determine the voltage across the bus capacitor in a following manner: establishing a correspondence relationship between the temperature and a bus voltage in advance, and determining the voltage across the bus capacitor according to the correspondence relationship in response to that the received temperature information triggers any preset threshold.

In some embodiments of the present disclosure, a temperature signal processing unit is configured to determine the voltage across the bus capacitor in a following manner: establishing a functional relationship between an amount of change in the voltage of the bus capacitor and an amount of change in the temperature in advance, obtaining a plurality pieces of the temperature information of the bus capacitor, determining the amount of change in the temperature, and determining the amount of change in the voltage across the bus capacitor corresponding to the amount of change in the temperature based on the amount of change in the temperature and the functional relationship.

According to a second aspect of the present disclosure, a control method for a switching power supply is further provided, where the switching power supply includes a PFC boost circuit and a bus capacitor, and the method includes: detecting a temperature of the bus capacitor and determining temperature information of the bus capacitor, where an input terminal of the PFC boost circuit is connected to a power source, and the bus capacitor is located at an output terminal of the PFC boost circuit; and adjusting a voltage across the bus capacitor in a preset manner according to the temperature information of the bus capacitor.

In some embodiments of the present disclosure, the preset manner includes: a two-segment manner, where in response to that the temperature information of the bus capacitor is lower than a preset threshold, the across the bus capacitor is adjusted to a first voltage according to a first preset value, and in response to that the temperature information of the bus capacitor is greater than a preset threshold, the voltage across the bus capacitor is adjusted to a second voltage according to a second preset value, where the first voltage is greater than the second voltage.

In some embodiments of the present disclosure, the preset manner includes: a multi-segment manner, where a correspondence relationship between the temperature and a bus voltage is established in advance, and the voltage across the bus capacitor is determined according to the correspondence relationship in response to that the temperature information of the bus capacitor triggers any preset threshold.

In some embodiments of the present disclosure, the preset manner includes: a linear manner, where a functional relationship between an amount of change in the voltage of the bus capacitor and an amount of change in the temperature is established in advance, a plurality pieces of the temperature information of the bus capacitor is obtained, the amount of change in the temperature is determined, and the amount of change in the voltage across the bus capacitor corresponding to the amount of change in the temperature is determined based on the amount of change in the temperature and the functional relationship.

According to a third aspect of the present disclosure, an electronic device is further provided, and the electronic device includes: a processor, and a memory configured to store executable instructions of the processor, where the processor is configured to execute the control method for the switching power supply described in any one of the first aspect by executing the executable instructions.

In the control method for the switching power supply provided in the embodiments of the present disclosure, the temperature information of the bus capacitor is determined by detecting the temperature of the bus capacitor, where the input terminal of the PFC boost circuit is connected to the power supply, and the bus capacitor is located at an output terminal of the PFC boost circuit; and the voltage across the bus capacitor is adjusted in a preset manner according to the temperature information of the bus capacitor. It realizes the corresponding modification of the amplitude of the adjustment of the PFC output voltage with the temperature. Not only does it have good heat dissipation, it can extend the life of the product under high temperature outdoor conditions, but can also mitigate the negative effects of performance degradation of the electrolytic capacitor caused by low temperature, so that the switching power supply can simultaneously meet the two requirements of high efficiency and long life.

It should be understood that the foregoing general description and the following detailed description are exemplary and explanatory only, and do not limit the present disclosure.

### BRIEF DESCRIPTION OF THE DRAWINGS

The accompanying drawings herein, which are incorporated in and constitute a part of this specification, illustrate embodiments consistent with the present disclosure and are used in conjunction with the specification to explain the principles of the present disclosure. Obviously, the drawings in the following description are only some embodiments of the present disclosure. For those of ordinary skill in the art, other drawings can also be obtained from these drawings without paying creative effort.

FIG. 1 shows a control method for a switching power supply in embodiments of the present disclosure;

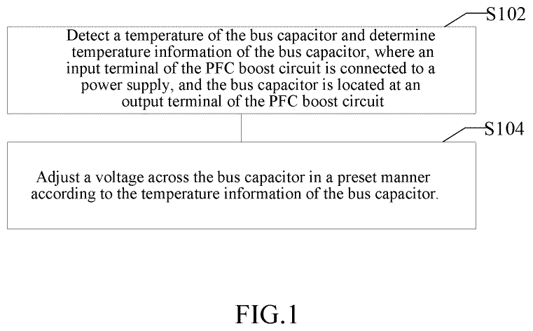

FIG. 2 shows a schematic diagram of a circuit structure of a switching power supply in embodiments of the present disclosure;

FIG. 3 shows a schematic diagram of a specific example of the circuit structure of the switching power supply in embodiments of the present disclosure;

FIG. 4 shows a two-segment temperature-voltage regulation in embodiments of the present disclosure;

FIG. 5 shows a multi-segment temperature-voltage regulation in embodiments of the present disclosure; and

FIG. 6 shows a continuous temperature-voltage regulation in embodiments of the present disclosure.

### DETAILED DESCRIPTION

Exemplary embodiments will now be described more fully with reference to the accompanying drawings. However, exemplary embodiments can be embodied in various forms and should not be construed as being limited to the examples set forth herein. On the contrary, these embodiments are provided so that the present disclosure will be more thorough and complete, and will fully convey the concepts of exemplary embodiments to those skilled in the art. The described features, structures or characteristics may be combined in any suitable manner in one or more embodiments.

In addition, the accompanying drawings are only schematic illustrations of the present disclosure and are not necessarily drawn to scale. In the accompanying drawings, the same reference sign indicates the same or similar part, and repeated descriptions thereof will be omitted. Some of the block diagrams shown in the accompanying drawings are functional entities and do not necessarily correspond to physically or logically separate entities. These functional entities may be implemented in software form, or in one or more hardware modules or integrated circuits, or in different networks and/or processor apparatuses and/or microcontroller apparatuses.

Specific implementation manners of embodiments of the present disclosure are described in detail below in conjunction with the accompanying drawings.

The switching power supply of the present disclosure detects a temperature of a bus capacitor, increases a given value of a PFC bus voltage at low temperatures, and decreases the given value of the bus voltage when the temperature rises.

The present disclosure detects the temperature inside the power supply (bus capacitor), increases the given value of the PFC bus voltage at low temperatures, and decreases the given value of the bus voltage correspondingly when the temperature rises.

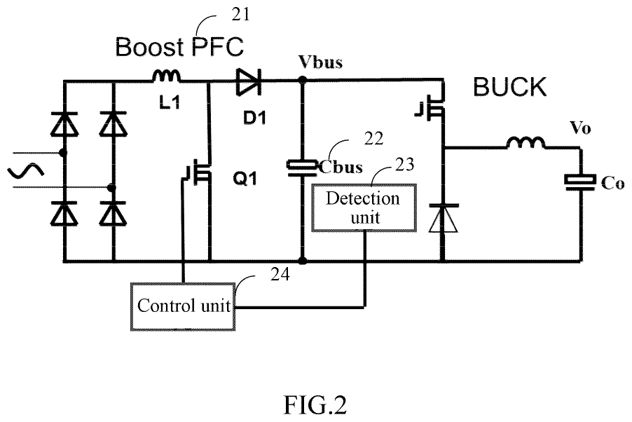

Specifically, embodiments of the present disclosure provide a control method for a switching power supply. The switching power supply includes a PFC boost circuit and a bus capacitor. As shown in FIG. 2, the control method for the switching power supply of the present disclosure includes the following steps.

In step S102, a temperature of the bus capacitor is detected and temperature information of the bus capacitor is determined, where an input terminal of the PFC boost circuit is connected to a power source, and the bus capacitor is located at an output terminal of the PFC boost circuit.

In step S104, a voltage across the bus capacitor is adjusted in a preset manner according to the temperature information of the bus capacitor.

It should be noted that the above-mentioned preset manner may be a segmented multi-stage manner (two-segment manner/multi-segment manner) and a continuous linear manner. For example, the PFC Bus voltage is automatically adjusted with the temperature, and when it is lower than the set threshold, the PFC output voltage is appropriately increased, and when it is higher than the set threshold, the PFC output voltage is automatically lowered, so that the difference between the input and output voltages of the PFC stage, and the difference between the input and output voltages of the second stage such as the Buck, become small, thereby improving the efficiency of the first and second stages and the entire machine. The adjustment may be two stages of temperature, or more stages. It should also be noted that as long as the approximate temperature range of the electrolytic capacitor can be detected, the component (such as an NTC temperature sensor) that detects the temperature of the bus capacitor may be placed close to the bus capacitor, or may be placed in other appropriate locations away from the bus capacitor in the power supply product.

In a specific embodiment of the present disclosure, in the above control method for the switching power supply, the preset manner includes: a two-segment manner, where in response to that the temperature information of the bus capacitor is lower than a preset threshold, the voltage across the bus capacitor is adjusted to a first voltage according to a first preset value, and in response to that the temperature information of the bus capacitor is greater than a preset threshold, the voltage across the bus capacitor is adjusted to a second voltage according to a second preset value, where the first voltage is greater than the second voltage.

In a specific embodiment of the present disclosure, in the above control method for the switching power supply, the preset manner includes: a multi-segment manner, where a correspondence relationship between the temperature and a bus voltage is established in advance, and the voltage across the bus capacitor is determined according to the correspondence relationship in response to that the temperature information of the bus capacitor triggers any preset threshold.

In a specific embodiment of the present disclosure, in the above control method for the switching power supply, the preset manner includes: a linear manner, where a functional relationship between an amount of change in the voltage of the bus capacitor and an amount of change in the temperature is established in advance, a plurality pieces of the temperature information of the bus capacitor is obtained, the amount of change in the temperature is determined, and the amount of change in the voltage across the bus capacitor corresponding to the amount of change in the temperature is determined based on the amount of change in the temperature and the functional relationship.

It can be seen from the above specific embodiments that the control method for the switching power supply provided by the embodiments of the present disclosure makes corresponding modification to the amplitude of adjustment of the PFC output voltage with the temperature according to different input and output conditions. Not only does it have good heat dissipation, it can extend the life of the product under high temperature outdoor conditions, but can also mitigate the negative effects of performance degradation of the electrolytic capacitor caused by low temperature, so that the switching power supply can simultaneously meet the two requirements of high efficiency and long life.

In order to meet performance under low temperature, the electrolytic capacitor needs to be selected as large as possible. However, due to the limitation of the size and space of the power supply, under a condition that four 100 uF/400V electrolytic capacitors of a certain model series are selected and connected in series and parallel two by two, and in the test and evaluation conditions of 220 Vac input and 300 Vdc/2 A output, the following comparison results are shown in Table 1.

TABLE 1

| | Bus design | Bus design | Start with full | | Efficiency |
|---|---|---|---|---|---|
| | voltage | voltage | load at a low | Start with | comparison of |
| | at −40° | above | temperature | full load | the two stages at |
| Condition | C. | 25° C. | of −40° C. | at 25° C. | room temperature |
| 1 | 520 V | 520 V | Normally start | Normally start | |
| | | | to operate | to operate | |
| 2 | 420 V | 420 V | Cannot start or | Normally start | Increase by 0.4% |
| | | | light flashes | to operate | compared to |
| | | | | | condition 1 |
| 3 | 520 V | 420 V | Start normally | Normally start | Increase by 0.4% |
| | | | | to operate | compared to |
| | | | | | condition 1 |

Table 1 compares condition 3 with conventional condition 1. The efficiency can be significantly improved at room temperature, which can effectively increase the power density of high-power power supplies and improve heat dissipation problems.

The present disclosure is easy to implement with low cost. Temperature judgments can be implemented as long as a temperature detection circuit is provided in the power supply, especially near the electrolytic capacitor. Both analog circuits and MCU control circuits may be used to control and switch the BUS low voltage. A point above the temperature at which the capacitance of the electrolytic capacitor starts to decay significantly may be selected as the switching point, e.g., room temperature, and an appropriate hysteresis range is set.

Based on the same inventive concept, embodiments of the present disclosure further provide a switching power supply, as described in the following embodiments. Since the principle of solving the problem in the present embodiment of the switching power supply is similar to that of the above-mentioned method embodiment, the implementation of the switching power supply embodiment may be referred to the implementation of the above-mentioned method embodiment, and repeated details will not be elaborated.

FIG. 2 shows a schematic diagram of a circuit structure of the switching power supply in the embodiments of the present disclosure. As shown in FIG. 2, the circuit structure of the switching power supply of the present disclosure includes: a PFC boost circuit 21, a bus capacitor 22, a detection unit 23 and a control unit 24.

An input terminal of the PFC boost circuit 21 is connected to a power source.

The bus capacitor 22 is located at an output terminal of the PFC boost circuit.

The detection unit 23 is configured to detect a temperature of an internal component of the switching power supply and output temperature information.

The control unit 24 is coupled to the detection unit and configured to adjust a voltage across the bus capacitor in a preset manner according to the temperature information output by the detection unit.

It should be noted here that the above-mentioned detection unit 23 corresponds to S102 in the method embodiment, and the above-mentioned control unit 24 corresponds to S104 in the method embodiment. The above detection unit 23 and the corresponding step implements the same examples and application scenarios thereof are the same, and the above control unit 24 and the corresponding step implements the same examples and application scenarios thereof are the same, but the units are not limited to the contents disclosed in the above method embodiments.

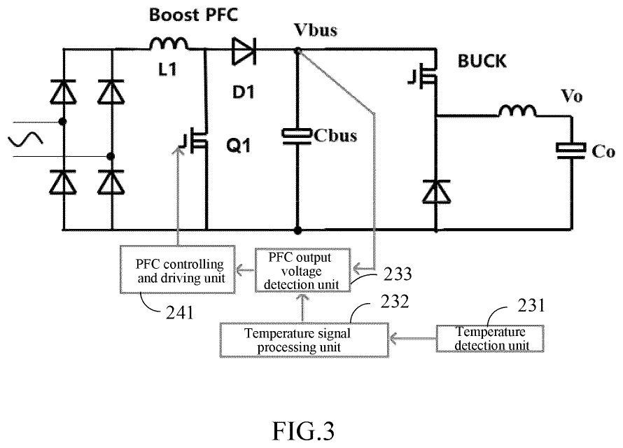

FIG. 3 shows a schematic diagram of a specific example of the circuit structure of the switching power supply in embodiments of the present disclosure. As shown in FIG. 3, the detection unit 23 includes a temperature detection unit 231, a temperature signal processing unit 232 and a PFC output voltage detection unit 233.

The temperature detection unit 231 may consist of an NTC or PTC temperature sensitive component, and information on the temperature value and change may be transmitted from this unit to a unit that adjusts the output voltage with the temperature. The location where the temperature detection unit 231 is placed may be near the Cbus. Since the accuracy of detection of the capacitor temperature is not required to be high, it may also be placed in other locations in the power supply product.

The temperature signal processing unit 232 may consist of an analog component or a circuit with an MCU controller. The temperature signal processing unit converts the received temperature information into a signal that adjusts the PFC output voltage and sends it to the PFC output voltage detection unit, so that the detection value of the output voltage can be adjusted, and then a duty cycle of Q1 is controlled by a PFC controlling and driving unit, thereby realizing the adjustment of the PFC output voltage with temperature. When the temperature is low, the Vbus voltage is appropriately increased; and when the temperature is high, the Vbus voltage is appropriately reduced.

The voltage detection unit 233 may consist of the PFC output voltage detection circuit, and the signal is fed back to the PFC controlling and driving unit to control a MOSFET Q1 so that the PFC output is stabilized accordingly.

In some embodiments of the present disclosure, the control unit 24 includes the PFC controlling and driving unit 241.

The PFC controlling and driving unit 241 may consist of an analog PFC control chip or a digital control chip and a corresponding MOSFET driving circuit.

In some embodiments of the present disclosure, the internal component of the switching power supply is the bus capacitor. When the internal component of the switching power supply is the bus capacitor, the temperature of the bus capacitor is directly detected, and the accuracy of temperature detection of the switching power supply is relatively high, which can achieve the beneficial effect of more accurate voltage control.

In some embodiments of the present disclosure, the control unit inversely adjusts the voltage across the bus capacitor according to the temperature information.

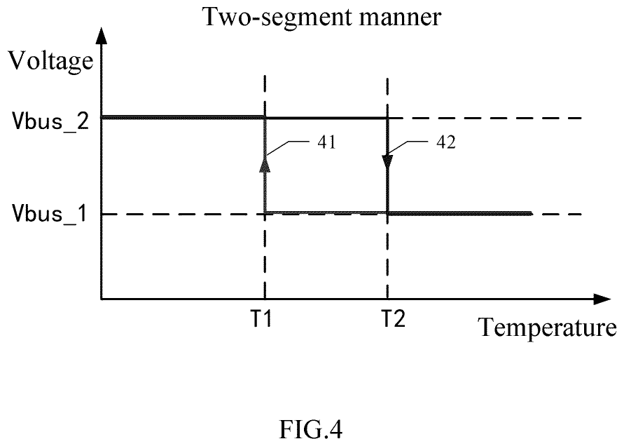

In some embodiments of the present disclosure, the temperature signal processing unit is configured to adjust the voltage across the bus capacitor in a following manner: when the received temperature information is lower than a preset threshold, adjusting the voltage across the bus capacitor to a first voltage according to a first preset value, and when the received temperature information is greater than a preset threshold, adjusting the voltage across the bus capacitor to a second voltage according to a second preset value, where the first voltage is greater than the second voltage. For example, temperature-voltage regulation is performed in a two-segment manner as shown in FIG. 4. The horizontal coordinate is the temperature, the vertical coordinate is the voltage, the upper and lower limits for voltage regulation are set to Vbus_1 and Vbus_2, and the temperature thresholds are set to T1 and T2. When the voltage decreases, the adjustment is performed according to the line segment 41; and when the voltage is increased, the adjustment is performed according to the line segment 42.

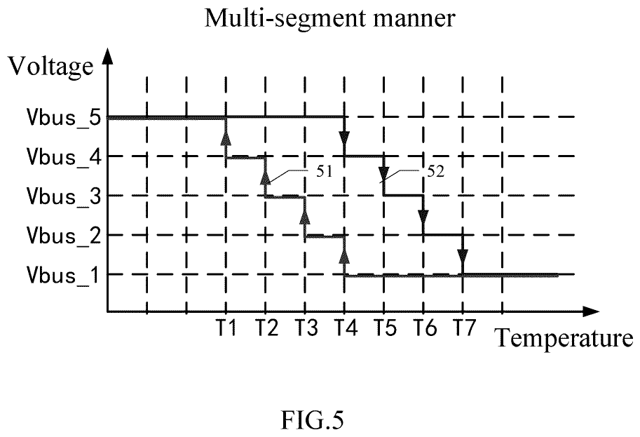

In some embodiments of the present disclosure, the temperature signal processing unit is configured to determine the voltage across the bus capacitor in a following manner: establishing a correspondence relationship between the temperature and a bus voltage in advance, and when the received temperature information triggers any preset threshold, determining the voltage across the bus capacitor according to the correspondence relationship. The temperature-voltage regulation is performed in a multi-segment manner as shown in FIG. 5. The horizontal coordinate is the temperature, the vertical coordinate is the voltage, the upper and lower limits for voltage regulation are set to Vbus_1 and Vbus_5, and the temperature thresholds are set to T1 and T7. The voltage includes Vbus_1, Vbus_2, Vbus_3, Vbus_4 and Vbus_5, and the temperature includes T1, T2, T3, T4, T5, T6 and T7. The multi-segment manner is an extension of the two-segment manner, with the same control and detection principles. When the voltage decreases, the adjustment is performed according to the line segment 51; and when the voltage is increased, adjustment is performed according to the line segment 52.

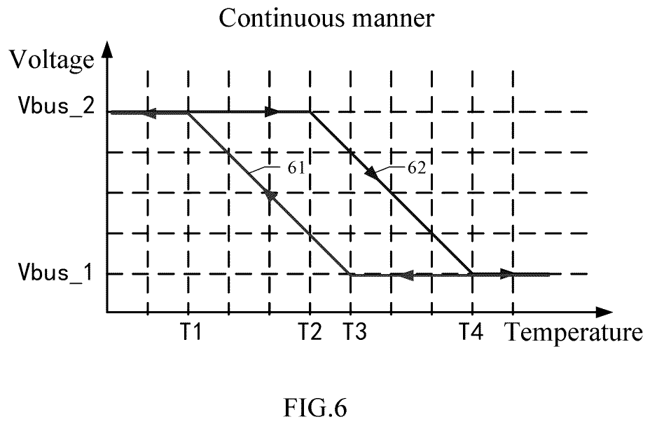

In some embodiments of the present disclosure, the temperature signal processing unit is configured to determine the voltage across the bus capacitor in a following manner: establishing a functional relationship between an amount of change in the voltage of the bus capacitor and an amount of change in the temperature in advance, obtaining a plurality pieces of the temperature information of the bus capacitor, determining the amount of change in the temperature, and determining the amount of change in the voltage across the bus capacitor corresponding to the amount of change in the temperature based on the amount of change in the temperature and the functional relationship. The temperature-voltage regulation is performed in a linear manner as shown in FIG. 6. The horizontal coordinate is the temperature, the vertical coordinate is the voltage, and the temperature includes T1, T2, T3 and T4. The operating mode includes a voltage decreasing process, in which the upper and lower limits for voltage regulation are set to Vbus_1 and Vbus_2, the temperature thresholds are set to T1 and T3, and a continuous temperature-voltage regulation with a slope of (Vbus_2−Vbus_1)/(T3−T1) is performed, i.e., the adjustment is performed according to the line segment 61. The operating mode includes a voltage increasing process, in which the upper and lower limits for voltage regulation are set to Vbus_1 and Vbus_2, the temperature thresholds are set to T2 and T4, and a continuous temperature-voltage regulation with a slope of (Vbus_2−Vbus_1)/(T4−T2) is performed, i.e., the adjustment is performed according to the line segment 62.

The present disclosure uses a two-stage circuit, where the first stage may be a variety of PFCs and the second stage may be a Buck or other isolated or non-isolated topology. The present disclosure is suitable for a wide temperature range and meets the specification requirements for low-temperature start-up applications at −25 degrees or even −40 degrees. The input and output voltages of the present disclosure are both in a wide range and may be applied to frequency converters or processes, power products for driving LED, outdoor high-power LED power supplies, and power products for outdoor applications that require low-temperature operating range and wide range of input and output, and particularly suitable for application in two-stage topology products where a Boost is combined with a Buck, which can realize the beneficial effects in efficiency, heat dissipation and power density.

It will be appreciated by those skilled in the art that various aspects of the present disclosure may be implemented as systems, methods or program products. Therefore, various aspects of the present disclosure may be specifically implemented in the following forms, i.e., a complete hardware implementation, a complete software implementation (including firmware, microcode, etc.), or an implementation combining hardware and software aspects, which may be collectively referred to herein as a “circuit”, “module” or “system”. It should be noted that although several modules or units of a device for action execution are mentioned in the above detailed description, such division is not mandatory. In fact, according to the embodiments of the present disclosure, the features and functions of two or more modules or units described above may be embodied in one module or unit. Conversely, the features and functions of one module or unit described above may be further divided to be embodied by multiple modules or units.

Furthermore, although various steps of the methods of the present disclosure are depicted in the drawings in a specific order, it does not require or imply that the steps must be performed in that specific order, or that all of the illustrated steps must be performed to achieve the desired results. Additionally or alternatively, certain steps may be omitted, multiple steps may be combined into one step for execution, and/or one step may be decomposed into multiple steps for execution, etc.

Through the description of the above embodiments, those skilled in the art may easily understand that the exemplary embodiments described here may be implemented by software or by software combined with necessary hardware(s). Therefore, the technical solutions according to the embodiments of the present disclosure may be embodied in the form of a software product that may be stored in a non-volatile storage medium (which may be a CD-ROM, a USB flash drive, a mobile hard disk, etc.) or on a network, and the software product includes several instructions to cause a computing device (which may be a personal computer, a server, a mobile terminal, a network device, etc.) to execute the method according to the embodiments of the present disclosure.

Other implementation manners of the present disclosure will be readily apparent to those skilled in the art upon consideration of the specification and practice of the present disclosure disclosed herein. The present disclosure is intended to cover any variations, uses, or adaptations of the present disclosure that follow the general principles of the present disclosure and include common knowledge or customary technical means in the technical field that are not disclosed in the present disclosure. The specification and embodiments are to be considered as exemplary only, and the true scope and spirit of the present disclosure are indicated by the appended claims.

What is claimed is:

1. A switching power supply, comprising:
a power factor correction (PFC) boost circuit, a bus capacitor, a detection unit and a control unit;
wherein an input terminal of the PFC boost circuit is connected to a power source;
the bus capacitor is located at an output terminal of the PFC boost circuit;
the detection unit is configured to detect a temperature of an internal component of the switching power supply and output temperature information; and
the control unit is coupled to the detection unit and configured to adjust a voltage across the bus capacitor in a preset manner according to the temperature information output by the detection unit.

2. The switching power supply according to claim 1, wherein the internal component of the switching power supply is the bus capacitor.

3. The switching power supply according to claim 1, wherein the control unit inversely adjusts the voltage across the bus capacitor according to the temperature information.

4. The switching power supply according to claim 3, wherein a temperature signal processing unit of the detection unit is configured to adjust the voltage across the bus capacitor in a following manner:
in response to that the temperature information is lower than a preset threshold, adjusting the voltage across the bus capacitor to a first voltage according to a first preset value, and in response to that the temperature information is greater than a preset threshold, adjusting the voltage across the bus capacitor to a second voltage according to a second preset value, wherein the first voltage is greater than the second voltage.

5. The switching power supply according to claim 3, wherein a temperature signal processing unit of the detection unit is configured to determine the voltage across the bus capacitor in a following manner:
establishing a correspondence relationship between the temperature and a bus voltage in advance, and determining the voltage across the bus capacitor according to the correspondence relationship in response to that the temperature information triggers any preset threshold.

6. The switching power supply according to claim 3, wherein a temperature signal processing unit of the detection unit is configured to determine the voltage across the bus capacitor in a following manner:
establishing a functional relationship between an amount of change in the voltage of the bus capacitor and an amount of change in the temperature in advance, obtaining a plurality pieces of the temperature information of the bus capacitor, determining the amount of change in the temperature, and determining the amount of change in the voltage across the bus capacitor corresponding to the amount of change in the temperature based on the amount of change in the temperature and the functional relationship.

7. A control method for a switching power supply, wherein the switching power supply comprises a PFC boost circuit and a bus capacitor, and the method comprises:
detecting a temperature of the bus capacitor and determining temperature information of the bus capacitor, wherein an input terminal of the PFC boost circuit is connected to a power source, and the bus capacitor is located at an output terminal of the PFC boost circuit; and
adjusting a voltage across the bus capacitor in a preset manner according to the temperature information of the bus capacitor.

8. The control method for the switching power supply according to claim 7, wherein the preset manner comprises:
a two-segment manner, wherein in response to that the temperature information of the bus capacitor is lower than a preset threshold, the voltage across the bus capacitor is adjusted to a first voltage according to a first preset value, and in response to that the temperature information of the bus capacitor is greater than a preset threshold, the voltage across the bus capacitor is adjusted to a second voltage according to a second preset value, wherein the first voltage is greater than the second voltage.

9. The control method for the switching power supply according to claim 7, wherein the preset manner comprises:
a multi-segment manner, wherein a correspondence relationship between the temperature and a bus voltage is established in advance, and the voltage across the bus capacitor is determined according to the correspondence relationship in response to that the temperature information of the bus capacitor triggers any preset threshold.

10. The control method for the switching power supply according to claim 7, wherein the preset manner comprises:
a linear manner, wherein a functional relationship between an amount of change in the voltage of the bus capacitor and an amount of change in the temperature is established in advance, a plurality pieces of the temperature information of the bus capacitor is obtained, the amount of change in the temperature is determined, and the amount of change in the voltage across the bus capacitor corresponding to the amount of change in the temperature is determined based on the amount of change in the temperature and the functional relationship.

11. An electronic device, comprising: a processor, and a memory configured to store executable instructions of the processor, wherein the processor is configured to execute the control method for a switching power supply according to claim 7.
